(19) United States
(12) Patent Application Publication
(10) Pub. No.: US 2013/0095275 A1
(43) Pub. Date: Apr. 18, 2013

(54) Passive Fireproofing System for Pipelines

(71) Applicant: Herbert Munzenberger, Wiesbaden (DE)

(72) Inventor: Herbert Munzenberger, Wiesbaden (DE)

(21) Appl. No.: 13/566,764

(22) Filed: Aug. 3, 2012

(30) Foreign Application Priority Data
Aug. 3, 2011 (DE) 102011080329.7

(51) Int. Cl. C09D 5/18

(52) U.S. Cl. CPC C09D 5/18
USPC 428/96; 156/60; 428/446; 442/136; 106/18.11; 106/18.12; 106/18.26; 106/18.27

(57) ABSTRACT

A lining and a related method for extending the period during which a line leg, such as a pipeline in a fireproofing installation, remains below a critical temperature are described. The lining includes, for example, a binding agent, endothermically degradable fillers and/or other fillers, if applicable. The method includes a wrapped line leg with the lining on both sides for wall feedthroughs and/or above the feedthrough opening for ceiling feedthroughs directly after the bulkheading of a feedthrough opening in a fireproofing installation. The heat removal from or the cooling of a line leg can be supported easily and applied on-site in such a way that even line legs with good thermal conductivity can achieve a high T-rating value in the fire test.

### CROSS-REFERENCE TO RELATED APPLICATIONS

The present application claims priority to German Patent Application No. DE 10 2011 080 329.7, filed Aug. 3, 2011, which is hereby incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Openings are provided in components in order to lead line legs such as conduits or pipelines through components such as walls, ceilings, etc. In many countries, the set-up of so-called fireproofing areas is required by law for special buildings including public buildings, hospitals, schools, etc. This is aimed at preventing the fire and the associated flue gases from spreading rapidly through the entire building in case of fire. Therefore, the openings must be sealed fire-proof and flue gas-proof to prevent the fire or flue gas from passing through the opening. A number of devices for the fire-proof and flue gas-proof feedthrough of a line leg through an opening created in a component having an elastic sealing body that contains at least one feedthrough opening have been disclosed.

A fire can spread by flames sparking over to a different room or a different floor. However, even if no flames spark over, fire can still develop in a room if the heat on the side of the wall facing away from the fire rises in temperature to the point where combustible materials self-ignite. In particular, pipelines made of materials with good thermal conductivity such as steel and metal pipes are a problem in this respect. They heat up as a result of the fire on one side of the component and conduct the heat through the component in spite of potentially available fireproofing devices, such as fireproof bulkheads, in such a way that the pipeline on the side of the component facing away from the fire heats up within a short period of time to the point where the flash point of adjacent materials, such as wallpaper, curtains, etc., can be reached. If this is the case, it can result in ignition and hence a fire is started on the side facing away from the fire.

In the United States, compliance with so-called T-rating limits is required increasingly more often for fireproofing applications in addition to the standards also common in Europe, such as the fire resistance duration of a component or bulkhead. In the United States, fireproofing systems are ASTM E814 (UL 1479)-tested, whereby two ratings are tested, namely the so-called F-rating and the T-rating. The F-rating defines the minimum period during which a fireproofing installation was tested and it was demonstrated that the fire was prevented from spreading. The T-rating indicates the period within which the temperature of a measured point on an installation on the side of a wall or ceiling opening facing away from the fire rises by 180 K compared to the starting temperature. This ensures that the temperature on the side facing away from the fire does not reach the flash point of any materials on that side of the wall, thus preventing self-ignition due to increased temperature.

In the event of a fire, the sealing bodies, masses or collars used for bulkheading the feedthroughs of non-metallic sealable line legs only prevent the toxic flue gases and the fire from spreading into the adjacent room. Moreover, hot air can be prevented from passing through the feedthrough or from being transported into the other room through the line legs.

Especially for feedthroughs of non-insulated line legs, in particular, pipes or conduits such as metal pipes through walls and ceilings, this cannot be realized without additional procedures, because the metal pipes or conduits transmit the heat through the bulkhead to the other side of the wall in spite of the bulkheading of the feedthrough due to their good thermal conductivity. As a result, the materials surrounding the pipe or adjacent to the pipe are also heated up, which can lead to the spreading of the fire when the respective ignition temperature is exceeded, in spite of the bulkheading of the feedthrough. The heat transmission through the wall or ceiling via pipelines is notable with thin walls and ceilings such as retroactively installed drywalls because the wall and ceiling thickness and the material they are made of is often inadequate to remove the heat from the heated pipeline.

This can be prevented with the implementation of additional precautions aimed at either preventing the excessive heating of the line leg, for example, the pipe or conduit, or by removing the heat transported through the pipe and conduit material such that the thermal conductivity along the line leg through the bulkheading is prevented or minimized such that the temperature of the pipe or the conduit on the side facing away from the fire does not reach the flash point of the adjacent materials.

Excessive heating can be prevented by enveloping the pipe or conduit with a non-flammable insulation layer such as described, for example, in U.S. Patent Publication No. 2006/0096207 A1. U.S. Patent Publication No. 2006/0096207 A1 discloses a device for cooling a pipeline that contains a plurality of individual cooling aggregates filled with water or a different suitable cooling agent, wherein the cooling aggregates are surrounded by a collar, which in turn is provided with ventilation channels.

The disadvantage of this solution is that a separate collar and a separate cooling aggregate with a corresponding circumference are required for every pipe circumference. This considerably increases the work and material expenditures.

Another option is to provide the line leg such as the pipe or the conduit with a coating such as is common for intumescent fireproofing.

The disadvantages of coatings include that they are expensive, difficult to apply and sensitive to mechanical stress or impact, and that their thermal conductivity is relatively low. Furthermore, the activation temperature of the fireproofing additives used in the coating to create an insulating ash layer generally ranges between 250° C. and 300° C., which is generally above the critical range of 180 K. The intumescence is only activated by the fireproofing additives when the critical range is exceeded.

### BRIEF SUMMARY OF THE INVENTION

Some embodiments of the present invention relate to the field of fireproofing. Some embodiments relate to a passive fireproofing system for line legs and, in particular, for pipelines made of metal or materials that include metal.

In some embodiments, heat can be conducted away from the pipelines on the side of the component facing away from the fire by means of a device to extend the time during which the temperature of the pipelines in the fireproofing installation remains below a threshold temperature (e.g., a critical temperature). In one embodiment, heat is conducted away from the pipelines to extend the time (e.g., duration, period, etc.) that the temperature at one or more measuring points remain below approximately 180 K above a starting temperature such as, for example, the room or ambient temperature. In some embodiments, the one or more measuring points are on the side of the component facing away from the fire.

### BRIEF DESCRIPTION OF SEVERAL VIEWS OF THE DRAWINGS

FIG. 1 shows a fireproofing installation that includes a wall opening bulkheaded with fireproofing material and a pipeline (without a lining) guided through the opening.

FIG. 2 shows a fireproofing installation that includes a wall opening bulkheaded with fireproofing material and a pipeline having a lining.

FIG. 3 shows a chart of temperature v. time for three measuring points over two embodiments.

FIG. 4 shows a chart of the temperature v. time for five measuring points over three embodiments.

### DETAILED DESCRIPTION OF THE INVENTION

Some embodiments provide a universal system that is easy to handle (e.g., can be easily adjusted to the different geometries of the line legs to be enveloped) and that is easy to adjust to the designed length. Some embodiments provide a universal system that is manufactured and processed economically, is harmless to the environment in the case of a fire and meets the applicable fireproofing regulations.

Some embodiments provide a lining that is wrapped around the line leg immediately subsequent (e.g., adjacent) to the bulkheading of the feedthrough opening in the component on both sides of wall feedthroughs and/or above the feedthrough opening of ceiling feedthroughs. The lining is capable of cooling the line leg if the temperature rises.

The term critical temperature used within the meaning of the invention means a temperature that exceeds the room or ambient temperature by more than 180 K. For a room temperature of 22° C., the critical temperature would be 202° C. A fireproofing installation is a feedthrough opening bulkheaded with fireproofing materials provided in a component through which pipelines have been laid. In the process, bulkheading is the sealing of the feedthrough opening that remains after the installation of the pipeline with fireproofing material such as foam or mortar to which fireproofing additives were added, and/or a preformed foam part capable of intumescence in the form of a brick or a mat or bags filled with fireproofing material. A line leg refers to both a single line such as, for example, a pipeline or a conduit, or a bundle comprising two or more lines, such as, for example, pipelines or conduits.

Some embodiments provide a lining that extends the period during which a line leg (e.g., a pipeline) in a fireproofing installation remains below a critical temperature. The lining can include, for example, a binding agent and endothermically degradable fillers. In some embodiments, the lining is fastened or attached directly on the line leg.

A function of the binding agent is to bind the endothermically degradable fillers as a layer on the line leg in which the fillers are mixed with the binding agent.

In some embodiments, the binding agent can include a kneadable or moldable mass, for example, an air-hardening binding agent. In some embodiments, the binding agent can include a mass based on silicates, in particular, water soluble silicates, for example, water glass (SiO₂/M₂O) such as sodium, potassium or lithium silicate (SiO₂/M₂O; M=Na, K, Li). In some embodiments, the binding agent includes a mass that includes water glass and water, wherein the binding agent contains 30 to 50 percent in weight of water glass (SiO₂/M₂O) and 70 to 50 percent in weight of water, relative to the binding agent.

In some embodiments, based on a mass including water glass and water, the binding agent dries in the air as a result of a chemical reaction. The mass hardens because of a reaction with carbon dioxide from the air by generating a glass. In some embodiments, no other procedures are required for fastening the lining on the line leg.

Some embodiments provide fillers that are endothermically degradable. In particular, this concerns dehydratable compounds, meaning that the compounds eliminate water, usually water of crystallization when exposed to heat, and break down in the process, with the formation of ceramic-like compounds. If a line leg wrapped in a lining according to some embodiments is heated to or above a temperature that corresponds to the decomposition temperature of the fillers, they eliminate water, whereby heat is removed from the line leg, thus cooling it. The generated water evaporates in the presence of sufficiently high heat, whereby the evaporation achieves an additional cooling of the line leg.

Aluminum hydroxide, aluminum oxide hydrates or partially hydrated aluminum hydroxides, for example, can be used as endothermically degradable fillers. However, other inorganic hydroxides or hydrates releasing water when exposed to heat can also be used such as, for example, boric acid and its partially dehydrated derivatives, as well as CaO.Al₂O₃.10H₂O (Nesquehonite), MgCO₃.3H₂O (Wermlandite), Ca₂Mg₁₄(Al,Fe)₄CO₃(OH)₄₂.29H₂O (Thaumasite), Ca₃Si(OH)₆(SO₄)(CO₃).12H₂O (Artinite), Mg₂(OH)₂CO₃.H₂O (Ettringite), 3CaO.Al₂O₃.3CaSO₄.32H₂O (Hydromagnesite), Mg₅(OH)₂(CO₃)₄.4H₂O (Hydrocalumite), Ca₄Al₂(OH)₁₄.6H₂O (Hydrotalcite), Mg₆Al₂(OH)₁₆CO₃.4H₂O (Alumohydrocalcite), CaAl₂(OH)₄(CO₃)₂.3H₂O (Scarbroite), AL₁₄(CO₃)₃(OH)₃₆ (Hydrogarnet), 3 CaO.Al₂O₃.6H₂O (Dawsonite), NaAl(OH)CO₃, CaSO₄.2H₂O (Gypsum), hydrated zeolites, vermiculites, zinc borate, Colemanite, Perlite, mica, alkaline silicates, borax, modified coals and graphites, silicic acids. Aluminum hydroxide, aluminum hydroxide hydrates, magnesium hydroxide and zinc borate, for example, can also be used because their activation temperature is below 180° C., which is below the critical temperature of about 205° C. with a room temperature of 25° C.

The ratio of fillers can account for 40 to 80 percent in weight and, in particular, 60 to 75 percent in weight relative to the total weight of the lining. If the ratio is lower than 40 percent in weight, adequate cooling can no longer be guaranteed, or the dimensions (width, thickness) of the lining need to be such that their use becomes unwieldy and uneconomical. If the ratio exceeds 80 percent in weight, the filler ratio of the lining combined with the water glass is so high that the obtained mass is too dry and can no longer be processed in a feasible manner.

In some embodiments, the lining additionally includes additional fillers selected from the group including chalk (CacO₃/MgCO₃), layered silicates, talc, Kaolin, Bentonite, and heavy spar (BaSO₄).

This helps reduce the content of relatively expensive endothermically degradable fillers, without impairing the cooling properties of the lining.

The other fillers can be contained at a quantity of up to 25 percent in weight relative to the total weight of the lining.

In some embodiments, the binding agent is applied onto a carrier.

In some embodiments, possible carrier choices include any materials which are sufficiently flexible to allow the lining be wrapped around line legs with different diameters. The function of the carrier is to maintain the shape of the mass that includes water glass, fillers and water for as long until it is self-supportive and has a stable shape after drying in the air. In some embodiments, since the carrier is not required any more after the mass has hardened, no requirements are specified with respect to the thermal stability of the carrier material.

In some embodiments, the carrier is a tissue, a knitted fabric or fleece. The carrier can be made of inorganic material such as mineral fibers or glass fibers.

The thickness and length of the lining are selected depending on the quality of the line leg such as the material (e.g., coefficient of thermal conductivity), diameter, wall strength, etc., such that a sufficient amount of heat can be removed to meet the fire test requirements according to ASTM E814 (UL1479).

Some embodiments provide a method for extending the period during which a line leg, such as, for example, a pipeline in a fireproofing installation remains below a critical temperature and hence a method for increasing the T-rating value of pipelines according to ASTM E814 (UL1479). In some embodiments, a lining as described above is wrapped around the line leg, such as, for example, a pipeline, immediately subsequent to the bulkheading of a feedthrough opening in a fireproofing installation on both sides of wall feedthroughs and/or above the feedthrough opening of ceiling feedthroughs.

In some embodiments, the line leg is wrapped with the lining at such a length in an axial direction of the line leg and with such a thickness in the radial direction of the line leg that the line leg is sufficiently cooled by the heat removing effect of the lining to meet the fire test requirements according to ASTM E814 (UL1479). In so doing, the length and the thickness are dependent on the quality of the line leg, such as the material (e.g., coefficient of thermal conductivity), diameter, wall strength, etc.

The easy use of the lining is disclosed herein. A liquid water glass is mixed with the endothermically degradable fillers and with the other fillers, if any, and packaged airtight, for example, under the exclusion of carbon dioxide. This allows for the fireproofing mass including binding agent and fillers to be stored for an extended period of time. A corresponding amount of fireproofing material is removed on site, applied to a carrier material, if applicable, and wrapped around a line leg. The width in the axial direction of the line leg and the thickness in the radial direction of the line leg are based on the material (e.g., coefficient of thermal conductivity λ), the circumference and the thickness (e.g., wall strength) of the pipeline. This can be calculated empirically based on the data for the line leg and the lining. After approximately two days, for example, the lining will have hardened into a glass-like body due to the hardening brought about by the carbon dioxide contained in the ambient air and automatically adheres to the line leg.

Some embodiments can be used for any line legs that have a coefficient of thermal conductivity with which the heat removal via the pipe section located in the bulkheaded opening of the component is so low that the temperature of the line leg on the side of the line leg facing away from the fire is able to rise to such an extent immediately after the opening in the component that the fire test requirements according to ASTM E814 (UL1479) are not met if the temperature is measured with a temperature sensor attached directly on the line leg. These can be non-insulated steel or metal pipes and conduits.

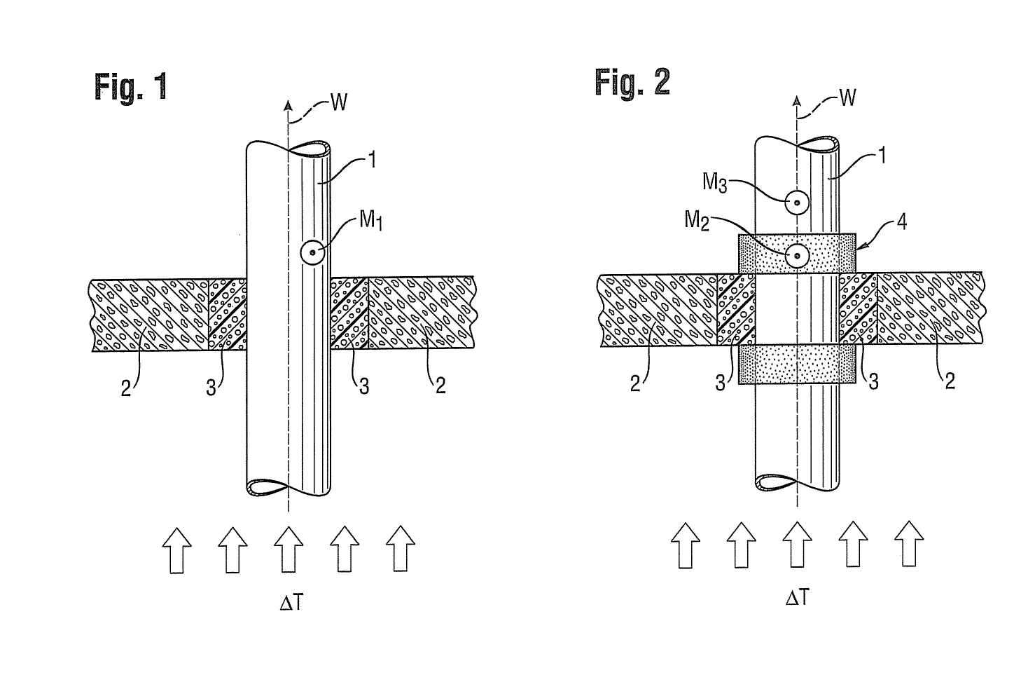

FIG. 1 shows a fireproofing installation having a pipeline (1) guided through a wall (2) through an opening. In the illustrated embodiment, the pipeline (1) is a copper pipe with a diameter of 76 mm. However, the pipeline can include any material with good thermal conductivity. The wall opening contains a flue gas-proof and fire-proof bulkhead with a fireproofing material (3). The fireproofing material can include, for example, a foam and/or a preformed foam part capable of intumescence in the form of a brick or a mat or bags filled with fireproofing material. During the fire test, one side is exposed to the flames, indicated with thick arrows. Accordingly, the heat conduction (W) through the pipeline material occurs from the fire-exposed side toward the direction of the side facing away from the fire.

During the fire test, the temperature is measured directly after the wall opening, wherein a temperature sensor (M₁) is mounted directly on the pipeline (1) at an axial distance of 25 mm from the wall bulkhead.

FIG. 2 shows the fireproofing installation of FIG. 1, in which the pipeline (1) is wrapped with a lining (4) according to the invention. The lining has a thickness of 12 mm in the radial direction of the pipeline (1) and a length of 125 mm in the axial direction of the pipeline (1). Again, one side is exposed to the flames during the fire test; in FIG. 2, this also corresponds to the direction from below as indicated with the thick arrows. Correspondingly, the heat conduction (W) within the pipeline occurs from the fire-exposed side toward the direction of the side of the wall opening facing away from the fire. The illustrated lining includes a mixture of 25 percent in weight of binding agent (e.g., liquid water glass: SiO₂/Na₂O; solid matter ratio 33-37%) and 75 percent in weight of aluminum trihydroxide, each relative to the mixture, wherein the mixture is provided with a fiberglass tissue as carrier. The fiberglass tissue forms the outermost layer of the lining in such a way that the mixture rests directly on the pipeline.

During the fire test, the temperature is once measured on the lining at an axial distance of 25 mm, wherein a temperature sensor (M₂) is attached directly on the lining and once at an axial distance from the wall bulkhead, directly after the lining (4), wherein a temperature sensor (M₃) is attached directly on the pipeline (1) after the lining (4).

For comparison purposes (not illustrated in the figures), the temperature gradient during the fire test is measured on a copper pipe with a diameter of 76 mm which is wrapped with a 30 mm thick and 125 mm wide mineral wool casing (Rockwool® Klimarock, thickness 30 mm, density 80 kg/m³; Deutsche Rockwool Mineralwoll GmbH & Co. KG). Here, the temperature is measured by means of two temperature sensors (M₄) and (M₅) at an axial distance of 25 mm on the casing (M₄) and once at an axial distance from the wall bulkhead, directly after the casing, wherein the temperature sensor here is attached directly on the pipeline (M₅).

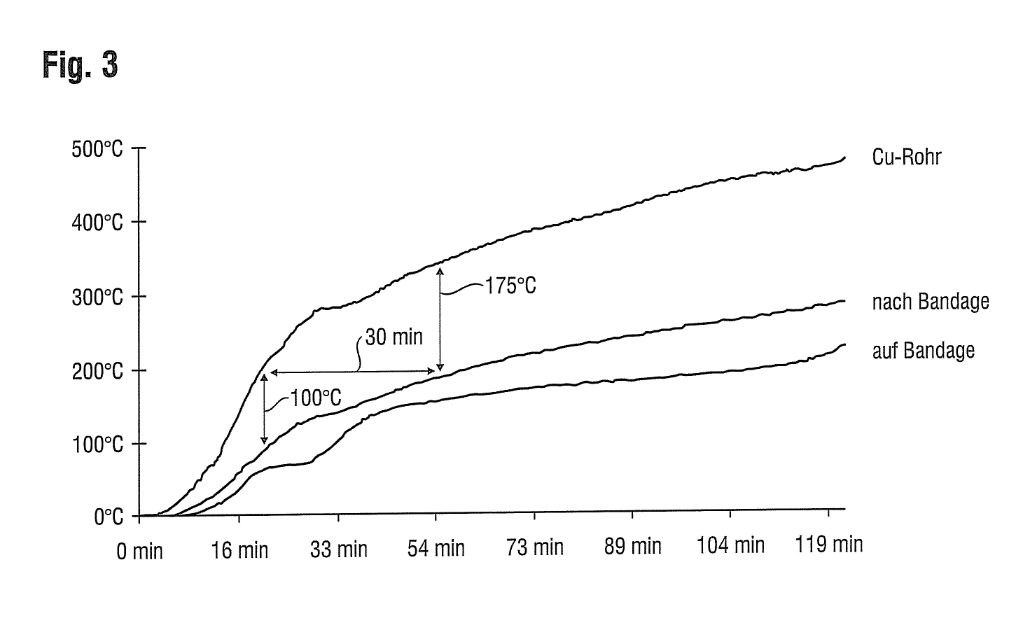

FIG. 3 shows the temperature gradient during the fire test for an estimated duration of 120 minutes at the measuring points M₁, M₂ and M₃, positioned as described above and illustrated in FIG. 1 and FIG. 2. The topmost curve corresponds to the temperature gradient for the blank copper tube at measuring point M₁; the middle curve corresponds to the temperature gradient for the copper pipe wrapped with a lining according to some embodiments at measuring point M₃ and the lowest curve corresponds to the temperature gradient for the copper tube wrapped with a lining according to some embodiments at the measuring point M₂.

As the curve in FIG. 3 demonstrates, the wrapping with the lining according to the invention has both an insulating and a cooling effect, such that the time elapsed until the temperature at the measuring points M₂ and M₃ has risen to a critical value is considerably prolonged. After about 20 minutes, the temperature at the measuring point M₃ is 100° C. lower than at measuring point M₁. The temperature of 200° C. is only reached about 30 minutes later at the measuring point M₃.

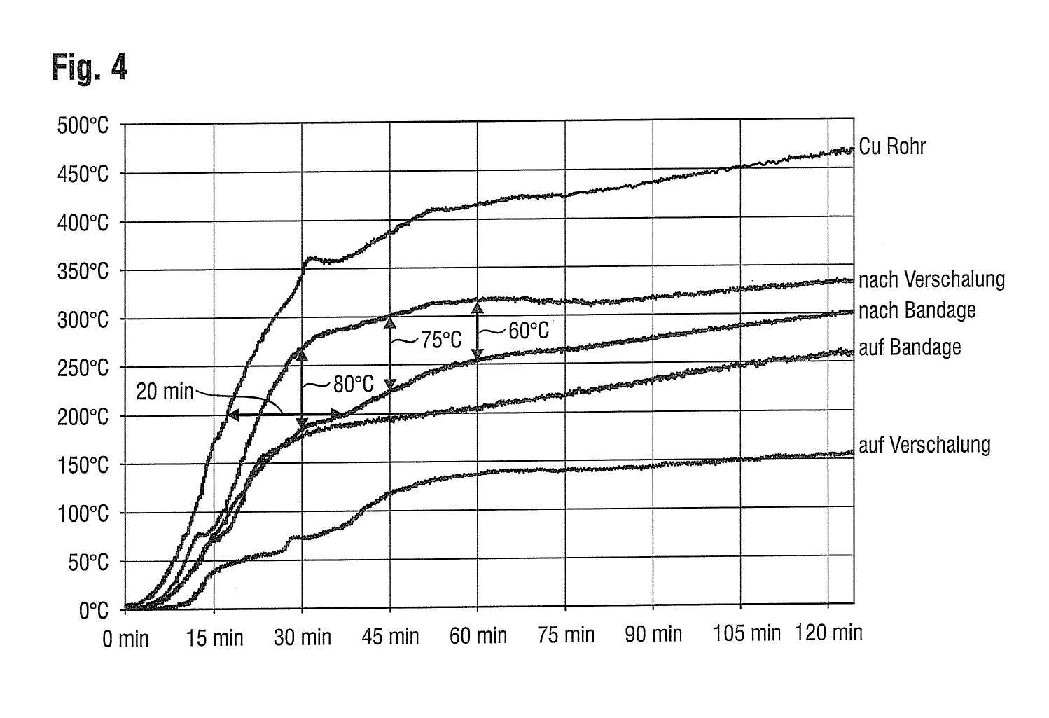

FIG. 4 shows the temperature gradient during the fire test for an estimated duration of 120 minutes at the measuring points M₁, M₂, M₃, M₄ and M₅ positioned as described above and illustrated in FIG. 1 and FIG. 2. The curves correspond to the temperature gradient at the measuring points M₁, M₅, M₃, M₂ and M₄ in descending order, that is, from top to bottom.

As the graphs in FIG. 4 illustrate, the temperature rises most quickly to a critical value on the blank copper pipe. From the point of view of the insulating effect, the wrapping using the lining according to the invention is not quite as effective as casing using mineral wool. Nevertheless, a clear shift of a critical temperature toward longer burning times is identified. The cooling effect of the lining according to some embodiments can be recognized based on the curves for the measuring points M₃ and M₅, wherein the temperature curve for the lining according to some embodiments is lower than the one for the mineral wool casing. A slow rise in temperature after the wrapping or the lining is documented. This again demonstrates that the lining according to some embodiments has both an insulating and a cooling effect such that the time elapsed until the temperature at the measuring point M₃ compared to M₅ has risen to a critical value is considerably prolonged. For example, the difference in temperature of the pipeline after the casing (M₅) and after the lining (M₃) according to some embodiments is 80° C. after 30 minutes and 60° C. after 60 minutes, indicating that a greater amount of heat is removed from the pipeline as a result of the lining.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. Lining for extending the duration during which a line leg in a fireproofing installation remains below a particular temperature, comprising:
a binding agent; and
endothermically degradable fillers.

2. The lining according to claim 1, wherein the lining is mounted directly on the line leg.

3. The lining according to claim 1, wherein the binding agent is based on SiO₂/M₂O, wherein M stands for one of Na, K and Li.

4. The lining according to claim 3, wherein the binding agent includes 30 to 50 percent in weight of SiO₂/M₂O relative to the binding agent.

5. The lining according to claim 4, wherein the binding agent includes 70 to 50 percent in weight of water relative to the binding agent.

6. The lining according to claim 1, wherein the endothermically degradable fillers comprise dehydratable compounds.

7. The lining according to claim 6, wherein the dehydratable compounds include one or more of the following: aluminum hydroxide, aluminum oxide hydrates or partially hydrated aluminum hydroxides, boric acid and its partially dehydrated derivatives, CaO.Al₂O₃.10H₂O (Nesquehonite), MgCo₃.3H₂O (Wermlandite), Ca₂Mg₁₄(Al,Fe)₄CO₃(OH)₄₂.29H₂O (Thaumasite), Ca₂Si(OH)₆(SO₄)(CO₃).12H₂O (Artinite), Mg₂(OH)₂CO₃.H₂O (Ettringite), 3CaO.Al₂O₃.3CaSO₄.32H₂O (Hydromagnesite), Mg₅(OH)₂(CO₃)₄.4H₂O (Hydrocalumite), Ca₄Al₂(OH)₁₄.6H₂O (Hydrotalcite), Mg₆Al₂(OH)₁₆CO₃.4H₂O (Alumohydrocalcite), CaAl₂(OH)₄(CO₃)₂.3H₂O (Scarbroite), Al₁₄(CO₃)₃(OH)₃₆ (Hydrogarnet), 3CaO.Al₂O₃.6H₂O (Dawsonite), NaAl(OH)CO₃, CaSO₄.2H₂O (Gypsum), hydrated zeolites, vermiculites, zinc borate, Colemanite, Perlite, mica, alkaline silicates, borax, modified coals, graphites, and silicic acids.

8. The lining according to claim 1, wherein the endothermically degradable fillers include one or more of the following: aluminum hydroxide, aluminum hydroxide hydrate, magnesium hydroxide, and zinc borate.

9. The lining according to claim 1, wherein the lining includes 20 to 60 percent in weight of the binding agent and 40 to 80 percent in weight of the endothermically degradable fillers.

10. The lining according to claim 1, comprising other fillers, wherein the other fillers include one or more of the following: chalk (CacO₃/MgCO₃), layered silicates, talc, Kaolin, Bentonite and heavy spar (BaSO₄).

11. The lining according to claim 10, wherein the lining includes up to 25 percent of the other fillers in weight relative to the total weight of the lining.

12. The lining according to claim 1, comprising other fillers, wherein the binding agent, the endothermically degradable fillers and the binding fillers form a mass that is applied onto a carrier.

13. The lining according to claim 1, wherein the binding agent and the endothermically degradable fillers form a mass that is applied onto a carrier.

14. The lining according to claim 13, wherein the carrier comprises one or more of the following: a tissue, a knitted fabric, and a fleece.

15. The lining according to claim 14, wherein carrier comprises inorganic material.

16. A method for extending the period during which a line leg in a fireproofing installation remains below a critical temperature, comprising:
providing a lining that includes a binding agent and endothermically degradable fillers; and
wrapping the lining around the line leg on one or both sides directly adjacent to the bulkheading of a feedthrough opening in a fireproof installation.

17. The method according to claim 16, wherein the lining is wrapped around the line leg with a length in the axial direction of the line leg and with a thickness in the radial direction of the line leg such that the line leg is cooled to extend a period of time during which the line leg in the fireproofing installation remains below a critical temperature.

18. The method according to claim 16, comprising:
insulating, via the lining, the line leg from heat on one side of a bulkhead with respect to the other side of the bulkhead.

19. The method according to claim 16, comprising:
cooling, via the lining, the line leg from the heat one side of a component with respect to the other side of the component.

20. The method according to claim 16, comprising:
cooling, via the lining, the line leg when the line leg is heated, wherein the lining includes water that is removed from the lining when the line leg is heated.
